(19) United States
(12) Patent Application Publication
(10) Pub. No.: US 2011/0311267 A1
(43) Pub. Date: Dec. 22, 2011

(54) DEVELOPING DEVICE, IMAGE FORMING APPARATUS AND METHOD

(75) Inventor: Kei Onishi, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/161,675

(22) Filed: Jun. 16, 2011

Related U.S. Application Data
(60) Provisional application No. 61/355,802, filed on Jun. 17, 2010.

(51) Int. Cl. G03G 15/09

(52) U.S. Cl. 399/104; 399/276; 399/277

(57) ABSTRACT

Certain embodiments provide a developing device including: a case; a cylindrical sleeve having a development region on the outer circumferential surface and a pair of non-development regions respectively in regions at both ends in an axis direction on the outer circumferential surface; a magnet on the inside of the sleeve; plural grooves each formed between both the ends along the axis direction; a pair of magnetic sheet metals provided spaced apart from the sleeve; and a pair of magnetic seal members provided spaced apart from the sleeve. When average groove depth of the plural grooves in the development region is represented as P, thicknesses t of the magnetic sheet metals are substantially t≧10×P (mm) and groove depths d of the plural grooves in the non-development regions of the sleeve are P/10≦d≦4P/5(mm).

### CROSS-REFERENCE TO RELATED APPLICATION

The present application claims priority under 35 U.S.C. 119 to U.S. Provisional Application Ser. No. 61/355,802, to Onishi, filed on Jun. 17, 2010, the entire disclosure of which is incorporated herein by reference.

### FIELD

Embodiments described herein relate generally to a developing device, an image forming apparatus, and a method of manufacturing the developing device.

### BACKGROUND

A developing device includes a magnet roll as a member for carrying a developer. The magnet roll includes a cylindrical sleeve. The sleeve includes, on the outer circumferential surface thereof, plural grooves machined in a V shape. The sleeve includes the grooves between one end and the other end of the sleeve.

The developing device includes, as a mechanism for preventing leakage of toner to the outside of the developing device, two magnetic sheet metals and two rubber magnets.

The developing device includes the two magnetic sheet metals and the two rubber magnets below the sleeve. The developing device has gaps between the two magnetic sheet metals and the sleeve.

Both surfaces of the two magnetic sheet metals are parallel to one end faces of plural magnets provided on the inside of the sleeve. Positions in the axis direction of rotation of the two magnetic sheet metals are further on the outer side than the one end faces. The outer side indicates one end from the center and the other end from the center in the axis direction.

Both positions in the axis direction of the two rubber magnets are further on the outer side than the positions of the two magnetic sheet metals. The developing device has gaps between the two rubber magnets and the sleeve.

With such a configuration, one magnetic sheet metal generates a magnetic line of force between the magnetic sheet metal and the plural magnets on the inside of the magnetic sheet metal. The magnetic line of force collects magnetic carriers. The collected carriers form a curtain.

The curtain of the carriers prevents the developer from moving to the outer side from a development region. The two rubber magnets capture a small amount of the magnetic carriers that leak further to the outer side than the magnetic sheet metals. The two rubber magnets seal magnetism. The developing device prevents leakage of the developer to the outside of the developing device.

In the related art, a manufacturing apparatus completely shaves off the V-shaped grooves on the outer circumferential surface on one end side of the sleeve and the V-shaped grooves on the outer circumferential surface on the other end side of the sleeve by machining. The manufacturing apparatus flattens unevenness on the outer circumferential surfaces on both the sides. Therefore, force for carrying the developer is weakened.

However, to completely shave off the V-shaped grooves on the outer circumferential surfaces on both the end sides of the sleeve requires high cost.

### BRIEF DESCRIPTION OF THE DRAWINGS

FIG. 1 is a diagram of an image forming apparatus according to an embodiment;

FIG. 2 is a plan view of a developing device according to the embodiment;

FIG. 3 is a longitudinal sectional view of the developing device according to the embodiment;

FIG. 4 is a partial plan view of the developing device according to the embodiment;

FIG. 5 is a top view of the arrangement of components of the developing device according to the embodiment;

FIG. 6A is a perspective view of one end in an axis direction in a state in which a sleeve of the developing device according to the embodiment is set;

FIG. 6B is a perspective view of one end in the axis direction in a state in which the sleeve of the developing device according to the embodiment is removed; and

FIG. 7 is a graph of a relation between sheet metal thickness and presence or absence of leakage of a developer (an example in a case of average groove depth P=0.1 mm of a development region).

### DETAILED DESCRIPTION

Certain embodiments provide a developing device including: a case including a chamber configured to store a developer; a cylindrical sleeve pivotably supported in the case and having a development region on an outer circumferential surface around an axis and a pair of non-development regions respectively in regions at both ends in an axis direction on the outer circumferential surface; a magnet having plural magnetic poles on an inside of the sleeve; plural grooves each formed between both the ends along the axis direction on the outer circumferential surface of the sleeve; a pair of magnetic sheet metals provided spaced apart from the sleeve further on an outer side than the development region in the axis direction in the case and having side surfaces orthogonal to the axis; and a pair of magnetic seal members provided spaced apart from the sleeve further on the outer side than the pair of magnetic sheet metals in the axis direction in the case and having surfaces opposed to the pair of non-development regions. When average groove depth of the plural grooves in the development region is represented as P, thicknesses t of the magnetic sheet metals is substantially greater than or equal to 10×P (mm), and groove depths d of the plural grooves in the non-development regions of the sleeve satisfies that d is greater than or equal to P/10 and smaller than or equal to 4P/5 (mm) (“x” represents multiplication. “/” represents division).

A developing device, an image forming apparatus, and a method of manufacturing the developing device are explained in detail below with reference to the accompanying drawings as examples. In the figures, the same components are denoted by the same reference numerals and signs and redundant explanation of the components is omitted.

A developing device according to an embodiment is a developing device including a mechanism for preventing leakage of a developer to the outside of a container. An image forming apparatus according to the embodiment is a copying machine of an electrophotographic system.

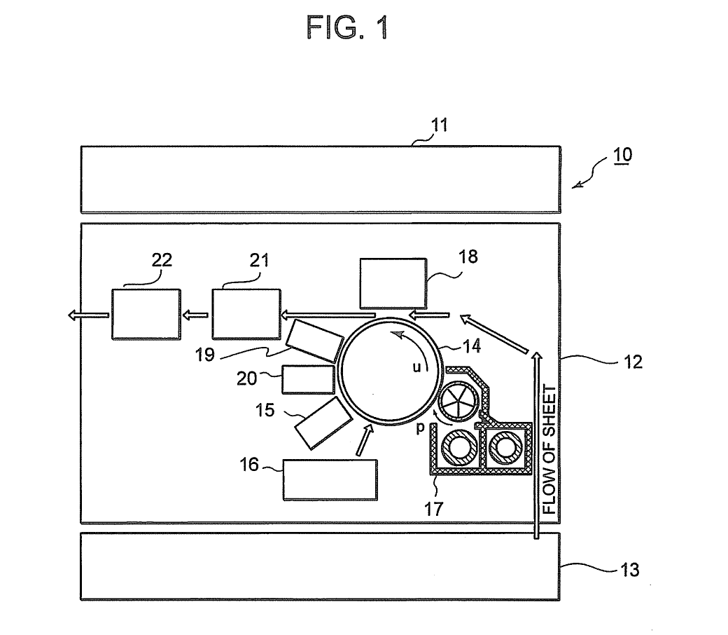

FIG. 1 is a diagram of the copying machine. A copying machine 10 includes a scanner 11 configured to optically read an image on a document surface, a printing section 12 configured to print image data on a sheet according to the electrophotographic system, and a paper feeding section 13 configured to feed a sheet to the printing section 12.

The printing section 12 includes a photoconductive drum 14 configured to rotate in an arrow u direction. The photoconductive drum 14 forms an image in an image region on the outer circumferential surface thereof.

The printing section 12 includes a charging device 15, a laser exposing device 16, a developing device 17, a transfer device 18, a charge removing device 19, and a cleaner 20 around the photoconductive drum 14.

The charging device 15 charges the outer circumferential surface of the photoconductive drum 14. The laser exposing device 16 includes a laser beam source. The laser exposing device 16 modulates a laser beam according to image data from the scanner 11.

The charging device 15 and the laser exposing device 16 configure a latent-image forming section. The laser exposing device 16 irradiates modulated light on a uniformly-charged outer circumferential surface region to thereby expose the photoconductive drum 14 to the light. The laser exposing device 16 forms an electrostatic latent image on the image region of the photoconductive drum 14.

The developing device 17 deposits a developer on the outer circumferential surface of the photoconductive drum 14 and develops the electrostatic latent image. The developer is a two-component developer mainly including toner and carriers. Toner particles are electrically charged. The carriers are magnetic particles.

The paper feeding section 13 conveys a sheet, to a nip position. The nip position indicates a position where the photoconductive drum 14 and the transfer device 18 are opposed to each other. The transfer device 18 transfers a toner image on the photoconductive drum 14 onto the sheet.

The charge removing device 19 removes surface charges of the photoconductive drum 14. The cleaner 20 removes the toner remaining on the surface of the photoconductive drum 14.

The copying machine 10 further includes a fixing device 21 into which a sheet carrying an unfixed toner image is inserted and a paper discharge section 22 provided further on a downstream side in a sheet conveying direction than the fixing device 21.

The fixing device 21 fixes the toner image on the sheet by heating and pressing the sheet. The paper discharge section 22 discharges the sheet subjected to the fixing to the outside of the copying machine 10.

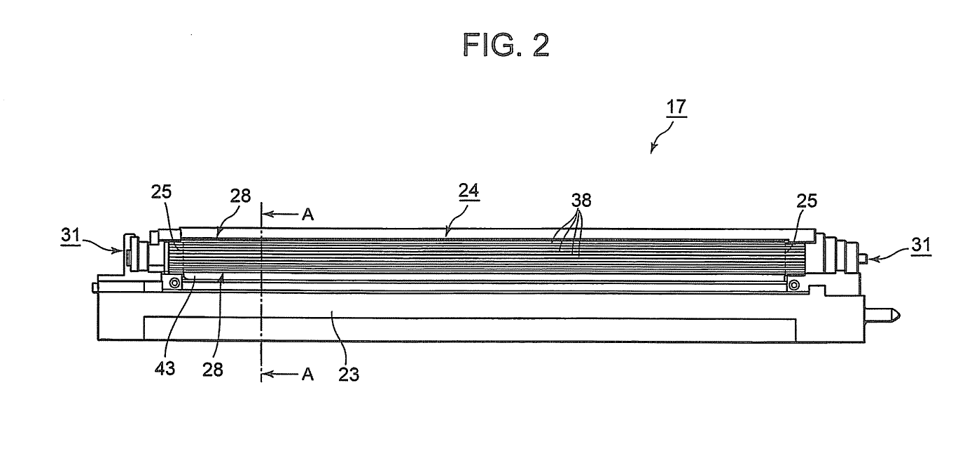

FIG. 2 is a plan view of the developing device 17.

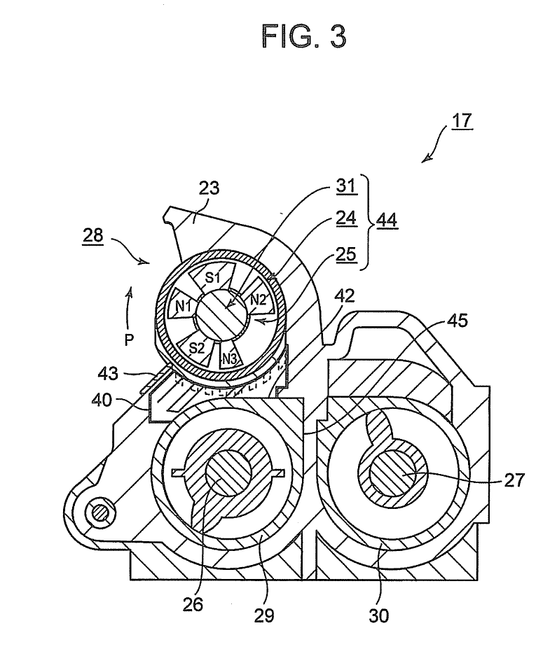

FIG. 3 is a longitudinal sectional view of the developing device 17 taken along a line AA′ in FIG. 2.

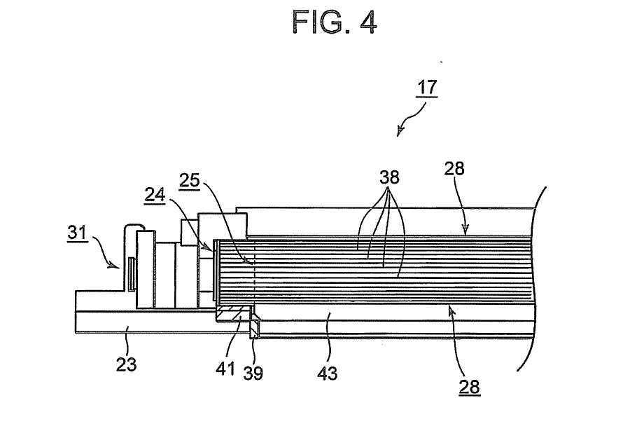

FIG. 4 is a partial plan view of one end in the axis direction of the developing device 17. In the figure, an end on the left side of a magnet roll 44 in a state in which a case 23 is removed from the developing device 17 of FIG. 2 is shown in enlargement.

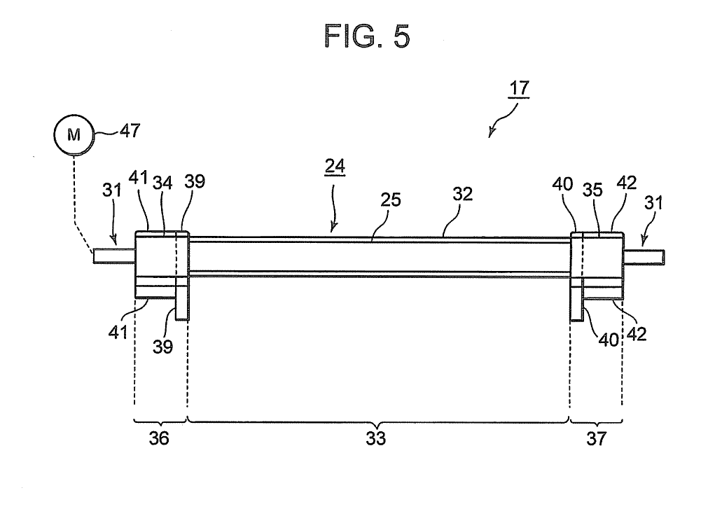

FIG. 5 is a top view of the arrangement of a magnet 25, a sleeve 24, magnetic sheet metals 39 and 40, and rubber magnets 41 and 42 of the developing device 17.

In FIGS. 2 to 5, the same reference numerals and signs denote the same components. Reference numerals and signs already described above denote the same components denoted by the reference numerals and signs.

The developing device 17 includes the case 23 configured to store the developer, the sleeve 24 of a cylindrical shape pivotably supported in the case 23, and the magnet 25 on the inside of the sleeve 24.

The case 23 includes an opening 28 facing the image region of the photoconductive drum 14 and chambers 29 and 30 each configured to store the developer.

The developer is a two-component developer including toner and carriers. The carriers are magnetic particles. A particle diameter of the carriers is equal to or greater than 20 μm and equal to or smaller than 50 μm.

A nonmagnetic material is used for the sleeve 24. The sleeve 24 is, for example, an aluminum pipe. The sleeve 24 includes bearing sections 31 respectively at both sleeve ends. The sleeve 24 is pivotably supported by the bearing sections 31 in the case 23.

The sleeve 24 has an outer circumferential surface 32 around the axis of rotation of the sleeve 24. A development region 33 is formed on the outer circumferential surface 32 of the sleeve 24. In the development region 33, the developer is supplied to the image region of the photoconductive drum 14 through the opening 28.

Non-development regions 36 and 37 are formed at sleeve ends 34 and 35 (both end regions in the axis direction) on the outer circumferential surface 32 of the sleeve 24.

The sleeve ends 34 and 35 respectively indicate belt-like regions around the axis on the outer circumferential surface 32. The non-development regions 36 and 37 are opposed to non-image regions of the photoconductive drum 14. Neither of the non-development regions 36 and 37 carries the developer.

The magnet 25 includes five pieces of permanent magnets. The respective pieces are long in the axis direction. The inner circumferential surface of the sleeve 24 is in contact with the outer circumferential surfaces of the respective permanent magnet pieces.

The developing device 17 includes a doctor blade 43. The doctor blade 43 includes a blade main body long in the axis direction of the sleeve 24 and a plate that fixes the blade main body to the case 23. The blade main body has magnetism.

The developing device 17 includes the doctor blade 43 with a gap formed between one side of the blade main body and the outer circumferential surface 32. The doctor blade 43 regulates the thickness of a layer of the developer adhering on the outer circumferential surface 32 of the sleeve 24.

The developing device 17 further includes mixers 26 and 27 respectively in the chambers 29 and 30. The case 23 has a wall 45 between the chambers 29 and 30. In the developing device 17, the wall 45 and a case wall are partially opened. The developing device 17 circulates the developer in the case 23.

Mainly the sleeve 24, the magnet 25, and the bearing sections 31 configure the magnet roll 44. A motor 47 turns the bearing sections 31. The sleeve 24 rotates. The magnet 25 remains fixed.

The magnet 25 generates a substantially-fixed magnetic field. The magnet 25 generates magnetic forces of five poles.

As shown in FIG. 3, the five poles indicate a development pole N1, a carrying pole S1, a peeling pole N2, a gripping pole N3, and a blade regulation pole S2. The development pole N1 forms a development nip in a development position. The carrying pole S1 carries the developer used for development into the case 23.

The peeling pole N2 peels the used developer off the sleeve 24. The gripping pole N3 grips a new developer. The blade regulation pole 52 is opposed to the doctor blade 43.

The sleeve 24 has plural V-shaped grooves 38 (grooves). In the sleeve 24, the V-shaped grooves 38 are machined by knurling (roulette) in advance.

The direction of the plural V-shaped grooves 38 are along the axis direction on the outer circumferential surface 32. The plural V-shaped grooves 38 are parallel to one another in the axis direction. Groove pitches of the plural V-shaped grooves 38 are substantially the same.

The V-shaped grooves 38 begin at one edge of the sleeve 24 and end at the other edge of the sleeve 24.

When the sleeve 24 is not machined at all, the groove depth at the sleeve ends 34 and 35 is equivalent to the groove depth in the development region 33.

The groove depth indicates height from a groove bottom to a groove bank of one groove.

In the sleeve 24, unevenness formed by the V-shaped grooves 38 is left in the non-development regions 36 and 37. In the sleeve 24, the unevenness is not flattened at all in the non-development regions 36 and 37.

The dimension of the unevenness in the non-development regions 36 and 37 is substantially equal to the groove depth of the V-shaped grooves 38 in the non-development regions 36 and 37. The dimension of the unevenness conditions that a dimension that does not cause leakage of the developer from the developing device 17. A dimension value does not have to be the maximum.

The inventor calculated a range of values of the groove depths in the non-development regions 36 and 37 with respect to the groove depth in the development region 33. Further, the inventor calculated a range of the thickness of the magnetic sheet metals 39 and 40 with respect to the groove depth in the development region 33.

The developing device 17 includes the pair of magnetic sheet metals 39 and 40 further on the outer side than the development region 33 in the axis direction. The magnetic sheet metals 39 and 40 regulate scattering of the developer, which is carried by the sleeve 24, to the outside of the case 23.

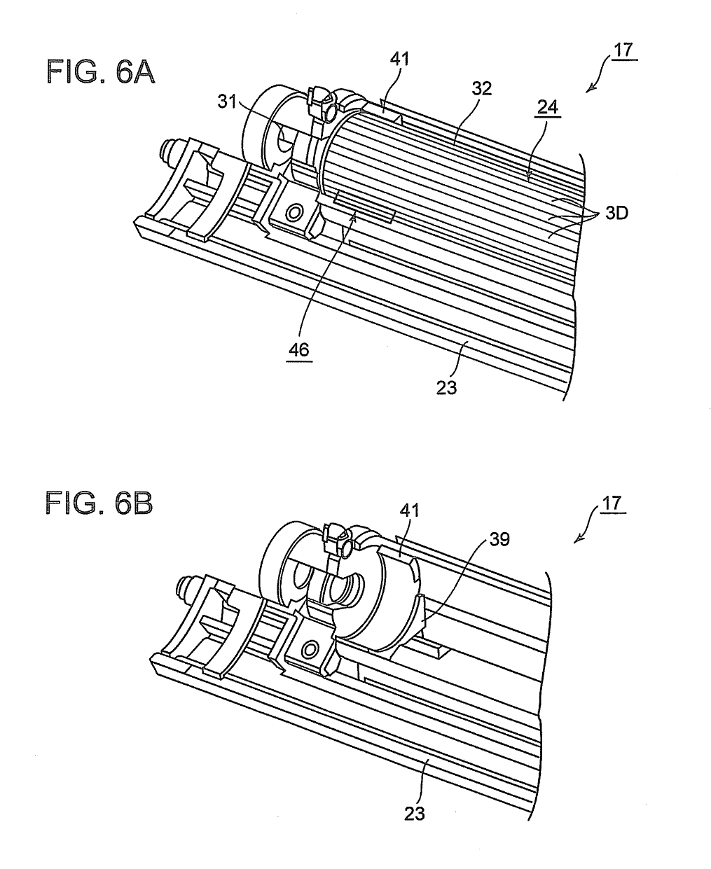

FIG. 6A is a perspective view of one end in the axis direction of the developing device 17. An example of a state in which the magnet roll 44 is set in the case 23 is shown. FIG. 6B is a perspective view of one end in the axis direction of the developing device 17. An example of a state in which the magnet roll 44 is removed from the case 23 is shown. The reference numerals already described above denote the same components denoted by the reference numerals.

The magnetic sheet metal 39 has a side surface orthogonal to the axis of the bearing section 31. The developing device 17 includes the magnetic sheet metal 39 to be spaced apart from the outer circumferential surface 32. A space between the pair of magnetic sheet metals 39 and 40 and the outer circumferential surface 32 is equal to or smaller than 1 mm. The magnetic sheet metal 39 does not prevent the rotation of the sleeve 24.

The developing device 17 includes the pair of rubber magnets 41 and 42 (magnetic seal members) further on the outer side than the magnetic sheet metal 39 in the axis direction. The rubber magnet 41 is formed mainly of a magnetic material.

The rubber magnet 41 has thickness in the radial direction. The rubber magnet 41 has a curved surface opposed to the non-development region 36.

The developing device 17 fixes the rubber magnet 41 with the curved surface spaced apart from the outer circumferential surface 32. The rubber magnet 41 does not apply resistance to the rotation of the sleeve 24.

The rubber magnet 41 captures the developer leaking from the center to the end side in the axis direction of the sleeve 24. The rubber magnet 41 captures the magnetic carriers.

The structure of the magnetic sheet metal 40 and the rubber magnet 42 on the other end side in the axis direction is substantially the same as the example of the magnetic sheet meal 39 and the rubber magnet 41. The thickness t of the magnetic sheet metal 40 and the thickness t of the magnetic sheet metal 39 are substantially the same.

A controller of the copying machine 10 (FIG. 1) having such a configuration detects that an original document is inserted into the scanner 11. The scanner 11 scans a document surface. The controller generates image data.

The controller turns the photoconductive drum 14 in the arrow u direction at process speed. The controller executes an image forming process on the surface of the photoconductive drum 14.

The controller turns the magnet roll 44 in an arrow p direction. The controller turns the magnet roll 44 and the photoconductive drum 14 at peripheral speeds different from each other.

The developing device 17 agitates the two-component developer in the case 23. The developing device 17 generates static electricity in the developer by friction.

The toner and the carriers are electrostatically combined by the static electricity. The toner and the carriers receive magnetic force that acts between the gripping pole N3 and the carriers.

The developing device 17 deposits, with magnetic force, the toner and the carriers on the outer circumferential surface 32 of the sleeve 24 near the gripping pole N3.

The developing device 17 carries the developer to a position of the blade regulation pole S2 adjacent to the gripping pole N3 according to the rotation of the sleeve 24. The doctor blade 43 causes, in conjunction with the blade regulation pole S2, the developer to pass through a gap between the doctor blade 43 and the blade regulation pole S2. The doctor blade 43 forms a layer of the developer having uniform layer thickness on the outer circumferential surface 32.

In the layer of the developer, plural carriers lie in a row along one line of magnetic force, whereby one chain is formed. Toner particles adhere to the carriers of plural chains, whereby a magnetic brush is formed.

The sleeve 24 further rotates. The developer in the layer state is carried from the position of the blade regulation pole S2 to a position of the development pole N1. The developing device 17 applies voltage to the sleeve 24.

In the development region 33, an electric field is generated by a difference between the potential of the sleeve 24 and the potential of the electrostatic latent image on the photoconductive drum 14.

The developing device 17 causes, with electric force, plural toner particles to fly onto the electrostatic latent image on the photoconductive drum 14. The developing device 17 visualizes the electrostatic latent image.

The copying machine 10 transfers a toner image developed in that way onto a sheet. The copying machine 10 fixes the toner image on the sheet. The copying machine 10 outputs the sheet.

Subsequently, the developing device 17 rotates the sleeve 24. The developing device 17 carries the toner particles and the carriers remaining on the outer circumferential surface 32 from the position of the development pole N1 to a position of the carrying pole S1 and then carries the toner particles and the carriers to a position of the peeling pole N2.

The peeling pole N2 and the gripping pole N3 cause force for peeling the carriers from the outer circumferential surface 32 of the sleeve 24 to act on the carriers. The developing device 17 peels, with the force, the carriers and the toner particles from the outer circumferential surface 32 and returns the carriers and the toner particles into the chamber 29.

On the sleeve end 34 side, the magnetic sheet metal 39 is magnetized by the magnetic force of the magnet 25. A magnetic circuit is generated between the magnet 25 and the magnetic sheet metal 39. A magnetic line of force generates a curtain of the carriers in a gap 46. The gap 46 is a space between the outer circumferential surface 32 and the rubber magnet 41.

The direction of a magnetic field is outward in the sleeve radial direction from the axis center in the axial section of the sleeve 24. Intervals of plural magnetic lines of force are dense. The developing device 17 causes the carriers near the magnetic sheet metal 39 to follow the direction of the magnetic field. The rubber magnet 41 captures the developer.

The developing device 17 seals an excess developer with the magnetic sheet metal 39 and the rubber magnet 41. The magnetic sheet metal 39 and the rubber magnet 41 spatially shield the bearing section 31 and the development region 33 from the developer.

On the sleeve end 35 side, like the example on the sleeve end 34 side, the developing device 17 prevents the developer from scattering from the development region 33 to the outside of the case 23.

The developing device 17 and a developing device according to a comparative example are explained below in comparison with each other.

The developing device according to the comparative example includes a sleeve having no V-shaped groove 38 at sleeve ends. A region without any unevenness substantially does not carry a developer. The sleeve according to the comparative example suppresses movement of the developer to both the sleeve ends.

A rubber magnet captures a small amount of magnetic carriers that leak from a magnetic seal. The developing device according to the comparative example prevents leakage of the developer to the outside of a container.

Naturally, in the developing device according to the comparative example, machining for completely shaving off V-shaped grooves on the sleeve both end regions leads to an increase in cost.

The machining for completely shaving off the V-shaped grooves imposes a manufacturer to perform a step of removing knurled V-shaped grooves of the sleeve and a step of inspecting removal of unevenness. The manufacturer requires time for the machining for the removal and the inspection. Therefore, man-hour and labor and time increase.

The inventor earnestly examined a relation between the thickness of the magnetic sheet metals 39 and 40 and the groove depth in the non-development regions 36 and 37 with respect to average groove depth in the development region 33.

The inventor found that the sleeve 24 is operable to suppress leakage of the developer without completely shaving off the V-shaped grooves in the sleeve both end regions unlike the sleeve according to the comparative example.

When average groove depth of the V-shaped grooves in the development region 33 of the sleeve 24 (equivalent to the image region of the photoconductive drum 14) is represented as P, a condition for P is a relation of Formula (1) below.

0.08≦P≦0.12(mm) (1)

In Formula (1) below, ≦ represents “smaller than or equal to”.

P and a carrying amount of the developer are in a proportional relation. The carrying amount affects image quality. A range of P is a proper value calculated by evaluating a relation between the carrying amount of the developer and the image quality.

A space between the magnetic sheet metals 39 and 40 and the outer circumferential surface 32 is equal to or smaller than 1 mm. An amount of carrying of the developer by the sleeve 24 in the development region 33 is 30 to 80 mg/cm². A particle diameter of the carriers is equal to or greater than 20 μm and equal to or smaller than 50 μm.

The inventor found that leakage of the developer from the developing device 17 did not occur when Formula (1) was satisfied and the thicknesses t of the magnetic sheet metals 39 and 40 and average groove depths d of the plural V-shaped grooves 38 in the non-development regions 36 and 37 satisfied Formula (2) below.

t≧10×P(mm); and P/10≦d≦4P/5(mm) (2)

In Formula (2), represents “greater than or equal to), × represents multiplication, and a sign / represents division.

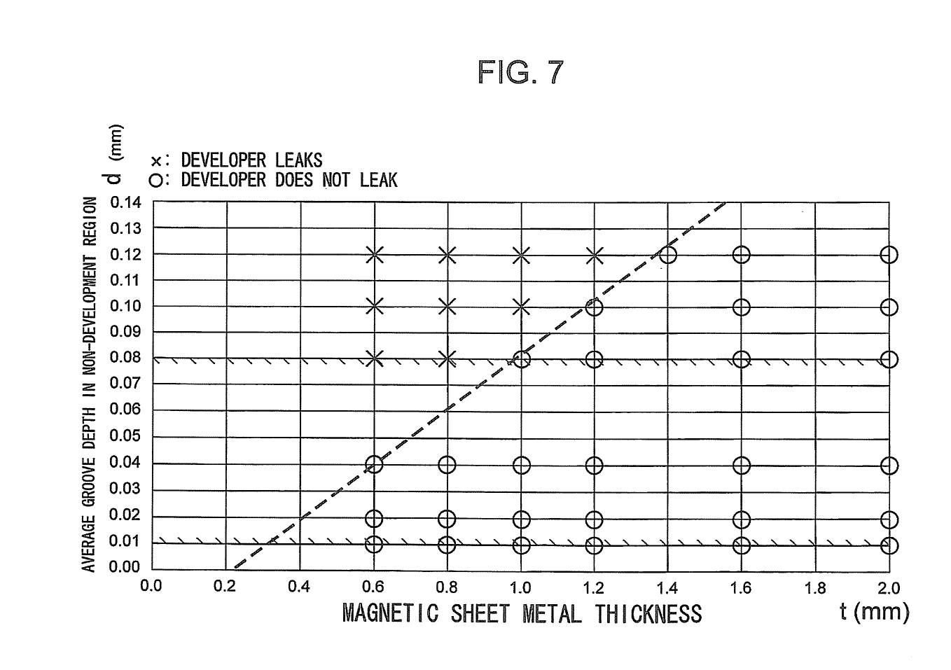

A relation between t and d at the time when average groove depth P in the development region is 0.1 mm is shown in FIG. 7.

FIG. 7 is a graph of a relation between sheet metal thickness and presence or absence of leakage of the developer. A broken line corresponds to the condition t=10×P. In the graph, marks represented by noughts (o) and marks represented by crosses (x) represent results of presence and absence of developer leakage in respective arbitrary number of (in an example of the figure, thirty-seven) the sleeves 24, respectively. The inventor visually determined presence or absence of leakage.

The developing device 17 including twenty-eight sleeves 24 each marked by the nought marks did not leak the developer after development. The results with the nought marks indicate satisfactory results.

The developing device 17 including nine sleeves 24 each marked by the cross marks leaked the developer after development. The results with the cross marks indicate unsatisfactory results.

A method of plotting the results shown in FIG. 7 is explained in (a) to (c) below.

(a) The inventor calculated a range of a proper value of the average groove depth P by evaluating a relation between the carrying amount of the developer and the image quality.

The sleeve 24 needs to carry a certain amount of the developer from the sleeve 24 onto the photoconductive drum 14.

When visually-observed image density is stable, this means that the carrying amount of the developer is large. A degree of easiness in carrying the developer by the sleeve is high. This is because the carrying amount is related to the average groove depth P.

The inventor repeated image formation using the plural sleeves 24 having different groove depths of the V-shaped grooves 38. As a result, the inventor obtains a range of Formula (1).

(b) The inventor evaluated a seal ability by the magnetic sheet metals 39 and 40. The inventor used the plural sleeves 24 respectively having substantially the same values of the average groove depth P in the development region 33.

The inventor evaluated the seal ability according to an amount of the developer adhering to the rubber magnets 41 and 42. This is because the rubber magnets 41 and 42 having a larger seal ability capture a larger amount of the developer.

In the evaluation measurement, the inventor used the average groove depths d in the non-development regions 36 and 37 as a parameter.

The inventor repeatedly set, using first average groove depth d, the plural sleeves 24 respectively having the different magnetic sheet metal thicknesses in the case 23 and drove the mixers 26 and 27 of the developing device 17. The inventor strongly agitated the developer for a fixed time using the developing device 17.

After the agitation, the inventor measured an amount (in a gram) of the developer adhering to the rubber magnets 41 and 42.

The inventor measured, using second average groove depth d, an amount of the developer adhering to the rubber magnets 41 and 42.

The inventor changed five average groove depths d in order and repeated work for measuring an amount of the adhering developer.

(c) As a result of the work, the inventor obtained the distribution of the amounts of the developer in which the magnetic sheet metal thicknesses t and the average groove depths d in the non-development regions 36 and 37 are variables.

The inventor confirmed that, when the amount of the developer adhering to the rubber magnets 41 and 42 exceeded 0.6 g, the developer leaked to the outside of the developing device 17.

Among plural results represented by the distribution of the amounts of the developer, the inventor sorted out, using the nought marks and cross marks, plural work results in which the amounts of the developer did not exceed 0.6 g and plural work results in which the amounts of the developer exceeded 0.6 g.

The inventor prepared a blank graph with the abscissa and the ordinate respectively represented as t and d. The inventor plotted, in the graph, values of the magnetic sheet metal thicknesses t, values of the average groove depths d, and the nought marks of the plural sleeves 24 used for the works in which the amounts of the developer did not exceed 0.6 g.

The inventor plotted, in the graph, values of the magnetic sheet metal thicknesses t, values of the average groove depths d, and the cross marks of the plural sleeves 24 used for the works in which the amounts of the developer exceeded 0.6 g.

After driving the developing device 17 for a fixed time, the inventor strongly agitated the developer. After work for visually determining whether the developer leaked to the outside of the developing device 17, the inventor calculated a relation between t and P.

The inventor represented, using the average groove depths P, the thicknesses t of the magnetic sheet metals 39 and 40 for not causing leakage of the developer. This is because the magnetic sheet metals 39 and 40 having the larger thicknesses t display higher seal performance.

In FIG. 7, the inventor plotted, using a broken line, a result indicating that the thickness t is equal to or greater than ten times of the average groove depth P in the development region.

In this way, the inventor obtained thirty-seven results shown in FIG. 7 and a range of Formula (2).

Actually, Formula (1) relates to an example in which the average groove depth P in the development region 33 is 0.1 mm, Formula (2) and FIG. 7 are explained below in comparison with each other.

The inventor prepared four kinds of sleeves 24, each of which had the average groove depth P of 0.1 mm and satisfied a relation 0.01≦d≦0.08.

In FIG. 7, attention is paid to a result on the abscissa t=1.0. The developing device 17 including respective four kinds of sleeves 24, each of which had the average groove depth d of 0.01 to 0.08 mm, did not leak the developer. Conversely, the developing device 17 including two kinds of sleeves, each of which had the average groove depth d larger than 0.08 mm, leaked the developer.

Attention is paid to a result on the abscissa t=0.6. The developing device 17 including respective three kinds of sleeves 24, each of which had the average groove depth d of 0.01 to 0.04 mm, did not leak the developer. Conversely, the developing device 17 including respective three kinds of sleeves, each of which had the average groove depth d larger than 0.08 mm, leaked the developer.

Attention is paid to a result on the abscissa t=1.2. The developing device 17 including respective five kinds of sleeves 24, each of which had the average groove depth d of 0.01 to 0.10 mm, did not leak the developer. Conversely, the developing device 17 including respective sleeves, each of which had the average groove depth d of 0.12 mm, leaked the developer.

In FIG. 7, measurement is not performed in an example of d=0 in which the average groove depths d in the non-development regions 36 and 37 are 0. The example of d=0 is not plotted because the sleeve 24 having unevenness left at the sleeve ends 34 and 35 is used.

In this way, the developing device 17 was able to confirm a remarkable effect that there was no leakage of the developer in the ranges of Formulas (1) and (2).

In general, as a method for preventing scattering of the developer to the outside of the developing device 17, there is a method of leaving the V-shaped grooves 38 at the sleeve both ends as indicated by FIG. 7 and a method of completely shaving off the unevenness of the non-development regions 36 and 37 at the sleeve both ends and smoothing the outer circumferential surface.

However, the method of smoothing the outer circumferential surface requires cost for machining. The developing device according to this embodiment can use the sleeve 24 in a state in which the unevenness is left without completely shaving off the V-shaped grooves 38.

In other words, in FIG. 7, it is indicated to which depth the V-shaped grooves 38 can be left.

The inventor confirmed a remarkable effect that the developer is prevented from leaking by using the sleeve 24 in which the average groove depths d of 40 μm in the non-development regions 36 and 37 at the sleeve both ends are left with respect to the average groove depth P of 100 μm in the development region.

It is assumed that a method of setting the groove depths of the V-shaped grooves 38 uniform in the axis direction is used. Carrying force for the developer in the non-development regions 36 and 37 is relatively higher than carrying force of the smooth surfaces on the sleeve ends 34 and 35 because of the V-shaped grooves 38 at the sleeve ends 34 and 35.

When the groove depth is uniform in the axis direction, the developer adhering to the rubber magnets 41 and 42 is carried by the V-shaped grooves 38. The developer leaks to the outside of the developing device 17 from the gaps 46 respectively formed between the rubber magnets 41 and 42 and the sleeve 24.

On the other hand, with the image forming apparatus and the developing device according to the embodiment, the developing device 17 is operative to minimize an amount of machining of the V-shaped grooves 38 in the sleeve 24. The developing device 17 is operable to prevent leakage of the developer while suppressing an increase in cost of the magnet roll 44 according to the minimization of the amount of machining.

In the developing device 17, the magnetic sheet metals 39 and 40 and the rubber magnets 41 and 42 are used as the leakage preventing mechanism for the developer. Therefore, the developing device 17 is capable of obtaining, while realizing a reduction in cost, the leakage preventing mechanism for the developer that can prevent leakage of the developer.

In this way, the developing device 17 is operable to prevent leakage of the developer to the outside of the developing device 17 by machining the sleeve ends 34 and 35 a little.

The sectional shape of the grooves is not limited to the V-shape. The sectional shape of the grooves may be, for example, a U-shape, a rectangular shape, a trapezoidal shape, or a W-shape. The tilt of groove walls of the V-shaped grooves 38 can be changed.

The groove depth may be defined by the height in the middle between the groove bottom to the groove bank. Presence or absence of leakage of the developer may be determined in the V-shaped grooves 38 having groove depths by different definitions.

Superiority of the developing device according to the embodiment is not spoiled at all over implemented products that are merely similar products of the developing device 17 obtained by, for example, enlarging or reducing the dimensions of the sleeve length and the sleeve diameter or enlarging or reducing the depth of the V-shaped grooves 38 and the dimension of the groove pitch.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the spirit of the inventions. The accompanying claims and their equivalents are intended to cover such forms or modifications as would fall within the scope and spirits of the inventions.

What is claimed is:

1. A developing device comprising:
a case including a chamber configured to store a developer;
a cylindrical sleeve pivotably supported in the case and having a development region on an outer circumferential surface around an axis and a pair of non-development regions respectively in regions at both ends in an axis direction on the outer circumferential surface;
a magnet having plural magnetic poles on an inside of the sleeve;
plural grooves each formed between both the ends along the axis direction on the outer circumferential surface of the sleeve;
a pair of magnetic sheet metals provided spaced apart from the sleeve further on an outer side than the development region in the axis direction in the case and having side surfaces orthogonal to the axis; and
a pair of magnetic seal members provided spaced apart from the sleeve further on the outer side than the pair of magnetic sheet metals in the axis direction in the case and having surfaces opposed to the pair of non-development regions,
when average groove depth of the plural grooves in the development region being represented as P, thicknesses t of the magnetic sheet metals being substantially greater than or equal to 10×P (mm), and groove depths d of the plural grooves in the non-development regions of the sleeve satisfying that the d is greater than or equal to P/10 and smaller than or equal to 4P/5 (mm).

2. The device of claim 1, wherein
the plural grooves are formed in a V-shape in a plane orthogonal to the axis, and
the P satisfies that the P is greater than or equal to 0.08 and smaller than or equal to 0.12 (mm).

3. The device of claim 1, wherein a space between the pair of magnetic sheet metals and the outer circumferential surface of the sleeve is equal to or smaller than 1 mm.

4. The device of claim 1, wherein an amount of the developer carried by the sleeve in the development region is 30 to 80 mg/cm².

5. The device of claim 3, wherein an amount of the developer carried by the sleeve in the development region is 30 to 80 mg/cm².

6. The device of claim 1, wherein
the developer in the case is a two-component developer mainly including toner and magnetic particles, and
a particle diameter of the magnetic particles is equal to or greater than 20 μm and equal to or smaller than 50 μm.

7. The device of claim 3, wherein
the developer in the case is a two-component developer mainly including toner and magnetic particles, and
a particle diameter of the magnetic particles is equal to or greater than 20 μm and equal to or smaller than 50 μm.

8. The device of claim 4, wherein
the developer in the case is a two-component developer mainly including toner and magnetic particles, and
a particle diameter of the magnetic particles is equal to or greater than 20 μm and equal to or smaller than 50 μm.

9. The device of claim 1, wherein the pair of magnetic sheet metals regulate scattering of the developer, which is carried by the sleeve, to an outside of the case.

10. The device of claim 1, wherein the magnetic seal members respectively capture the developer that leaks from the center to end sides in the axis direction of the sleeve.

11. The device of claim 1, wherein all the plural grooves are roulette grooves.

12. An image forming apparatus comprising:
a photoconductive drum having an image region on an outer circumference surface thereof;
a latent-image forming section configured to form an electrostatic latent image on the image region of the photoconductive drum according to irradiation of a laser beam;
a case including an opening facing the image region of the photoconductive drum and a chamber configured to store a developer that adheres to the electrostatic latent image from the opening;
a cylindrical sleeve pivotably supported in the case and having a development region on an outer circumferential surface around an axis and a pair of non-development regions respectively in regions at both ends in an axis direction on the outer circumferential surface;
a magnet having plural magnetic poles on an inside of the sleeve;
plural grooves each formed between both the ends along the axis direction on the outer circumferential surface of the sleeve;
a pair of magnetic sheet metals provided spaced apart from the sleeve further on an outer side than the development region in the axis direction in the case and having side surfaces orthogonal to the axis; and
a pair of magnetic seal members provided spaced apart from the sleeve further on the outer side than the pair of magnetic sheet metals in the axis direction in the case and having surfaces opposed to the pair of non-development regions,
when average groove depth of the plural grooves in the development region being represented as P, thicknesses t of the magnetic sheet metals being substantially greater than or equal to 10×P (mm), and groove depths d of the plural grooves in the non-development regions of the sleeve satisfying that the d is greater than or equal to P/10 and smaller than or equal to 4P/5 (mm).

13. The apparatus of claim 12, wherein
the plural grooves are formed in a V-shape in a plane orthogonal to the axis, and
the P satisfies that the P is greater than or equal to 0.08 and smaller than or equal to 0.12 (mm).

14. The apparatus of claim 12, wherein a space between the pair of magnetic sheet metals and the outer circumferential surface of the sleeve is equal to or smaller than 1 mm.

15. The apparatus of claim 12, wherein an amount of the developer carried by the sleeve in the development region is 30 to 80 mg/cm².

16. The apparatus of claim 12, wherein
the developer in the case is a two-component developer mainly including toner and magnetic particles, and
a particle diameter of the magnetic particles is equal to or greater than 20 μm and equal to or smaller than 50 μm.

17. A method of manufacturing a developing device, comprising:
providing, in a case including a chamber configured to store a developer, below a space in which a cylindrical sleeve is about to be placed, a pair of magnetic sheet metals located further on an outer side than a development region in an axis direction of the sleeve and having side surfaces orthogonal to a sleeve axis;
providing, in the case, below the space, a pair of magnetic seal members located further on the outer side in the axis direction than the pair of magnetic sheet metals and having surfaces curved in a cylindrical shape around the sleeve axis; and
pivotably supporting the sleeve in the case to be spaced apart from the pair of magnetic sheet metals and the pair of magnetic seal members, the sleeve including a magnet, which has plural magnetic poles on an inside, and plural grooves, which are formed between both the ends along the axis direction on an outer circumferential surface thereof,
average groove depth P of the plural grooves in the development region being greater than or equal to 0.08 and smaller than or equal to 0.12 (mm), thicknesses t of the magnetic sheet metals being substantially greater than or equal to 10×P (mm), and groove depths d of the plural grooves in a pair of non-development regions respectively in regions at both ends in the axis direction on the outer circumferential surface satisfying that the d is greater than or equal to P/10 and smaller than or equal to 4P/5 (mm).

18. The method of claim 17, wherein
in providing the pair of magnetic sheet metals, a space between the pair of magnetic sheet metals and the outer circumferential surface of the sleeve is set equal to or smaller than 1 mm.

19. The method of claim 17, wherein
in pivotably supporting the sleeve, the sleeve is activated to carry an amount of the developer in the development region 30 to 80 mg/cm².

20. The method of claim 17, wherein
in providing, in the case including the chamber, the pair of magnetic sheet metals,
the developer in the case is a two-component developer mainly including toner and magnetic particles, and
a particle diameter of the magnetic particles is equal to or greater than 20 μm and equal to or smaller than 50 μm.
